(19) United States
(12) Patent Application Publication
(10) Pub. No.: US 2017/0160795 A1
(43) Pub. Date: Jun. 8, 2017

(54) METHOD AND DEVICE FOR IMAGE RENDERING PROCESSING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xuelian HU, Tianjin (CN)

(21) Appl. No.: 15/246,396

(22) Filed: Aug. 24, 2016

Related U.S. Application Data
(63) Continuation of application No. PCT/CN2016/089271, filed on Jul. 7, 2016.

(30) Foreign Application Priority Data
Dec. 4, 2015 (CN) 201510889836.6

(51) Int. Cl. G06F 3/01; G06T 11/20

(52) U.S. Cl. CPC G06F 3/012; G06T 11/20

(57) ABSTRACT

The embodiment of the present disclosure discloses a method and device for image rendering processing. The method comprises: detecting a state of a target head to generate a target state sequence; when determining that the target head enters into a moving state, simulating the target state sequence to generate a fitting curve; confirming a field angle of a target scene according to a pre-generated frame delay time and the fitting curve; rendering the target scene on the basis of the field angle to generate a rendered image. According to an embodiment of the present disclosure, the moving state of the target head can be predicted according to the fitting curve to compensate an estimated field angle deviation, then a field angle deviation of an image frame at the beginning and at the end of rendering can be effectively reduced.

### CROSS-REFERENCE TO RELATED APPLICATIONS

The present disclosure is a continuation of International Application No. PCT/CN2016/089271 filed on Jul. 7, 2016, which is based upon and claims priority to Chinese Patent Application No. 201510889836,6, entitled “METHOD AND DEVICE FOR IMAGE RENDERING PROCESSING”, filed Dec. 4, 2015, and the entire contents of all of which are incorporated herein by reference.

### TECHNICAL FIELD

The present disclosure generally relates to the technical field of virtual reality, and in particular to a method for image rendering processing and a device for image rendering processing.

### BACKGROUND

Virtual Reality (VR) is also called Virtual Reality Technology or Virtual Reality Technology, and is a multi-dimensional environment of vision, hearing, touch sensation and the like partially or completely generated by a computer. By auxiliary sensing equipment such as a hamlet display and a pair of data gloves, a multi-dimensional man-machine interface for observing and interacting with a virtual environment is provided, a person can be enabled to enter the virtual environment to directly observe internal change of an article and interact with the article, and a reality sense of “being personally on a scene” is achieved.

Along with rapid development of the VR technology, a VR cinema system based on a mobile terminal is also rapidly developed. In the VR cinema system based on the mobile terminal, the view of an image can be changed by head tracking, the visual system and the motion perception system of a user can be associated, and thus relatively real sensation can be achieved. Specifically, in the VR cinema system based on the mobile terminal, when different image frames of a video need to be displayed on a screen, procedures of acquiring the head states of the user, calculating field angles, rendering scenes and videos according to the field angles, implementing counter-distortion, reverse dispersion and TimeWarp processing and the like are needed. However, in the process of realizing the present disclosure, the inventor finds that the processing procedures of acquiring the head states of the user, calculating the field angles and rendering the scenes and the videos according to the field angles take certain time, so that when the head of the user turns around, deviation between a field angle at the beginning of rendering and another field angle at the end of rendering can be resulted, an image which is actually displayed on the mobile terminal has deviation from an image to be displayed in a current position of the user, a scene image actually watched by eyes of the user has deviation from the current position, and then the user can feel dizzy in the watching process. The longer the image frame display delay time is, the faster the head turns, and the larger the deviation between field angels at the beginning of rendering and at the end of rendering is, so that the scene image actually watched by the eyes of the user has deviation from the current position, the user can feel dizzier when watching the video, that is, a relatively poor image display effect can be resulted, and the video play effect can be affected.

Obviously, in the VR cinema system based on the mobile terminal, because of the problem of field angle deviation at the beginning of image frame rendering and at the end of image frame rendering, the scene image actually displayed on the mobile terminal has relatively large deviation from an image to be displayed in the current position of the user.

### SUMMARY

The embodiment of the present disclosure aims to solve the technical problems of disclosing a method for image rendering processing mid reducing field angle deviation at the beginning of image rendering and at the end of image rendering to solve the problem of a poor image display effect caused by field angle deviation.

Correspondingly, the embodiment of the present disclosure further provides a device for image rendering processing to ensure realization and application of the method.

To solve the problem above, an embodiment of the present disclosure discloses a method for image rendering processing, including:
detecting states of a target head to generate a target state sequence;
when determining that the target head enters into a moving state, simulating the target state sequence to generate a fitting curve;
confirming a field angle of a target scene according to pre-generated frame delay time and the fitting curve;
rendering the target scene on the basis of the field angle to generate a rendered image.

Correspondingly, an embodiment of the present disclosure further discloses an electronic device for image rendering processing, including: at least one processor; and a memory communicably connected with the at least one processor for storing instructions executable by the at least one processor, wherein execution of the instructions by the at least one processor causes the at least one processor to:
detect states of a target head to generate a target state sequence;
simulate the target state sequence to generate a fitting curve when determining that the target head enters into a moving state;
confirm a field angle of a target scene according to pre-generated frame delay time and the fitting curve;
render the target scene on the basis of the field angle to generate a rendered image.

An embodiment of the present disclosure discloses a computer program, which includes computer readable codes for enabling an intelligent terminal to execute the method for image rendering processing according to above when the computer readable codes are operated on the intelligent terminal.

An embodiment of the present disclosure discloses a non-transitory computer readable medium storing executable instructions that, when executed by an electronic device, cause the electronic device to: detect states of a target head to generate a target state sequence; simulate the target state sequence to generate a fitting curve when determining that the target head enters into a moving state; confirm a field angle of a target scene according to pre-generated frame delay time and the fitting curve; render the target scene on the basis of the field angle to generate a rendered image.

Compared with the prior art, the embodiment of the present disclosure has the following advantages:
according to the embodiment of the present disclosure, a target state sequence is generated by detecting the state of a target head, and a fitting curve is generated by simulating a target state sequence when determining that the target head enters into a moving state; a field angle of a target scene is continued according to the frame delay time and the fitting curve, that is, the moving state of the target head is predicted on the basis of the fitting curve, and estimated field angle, deviation can be compensated, so that field angle deviation caused at the beginning and at the end of image frame rendering can be effectively reduced, the dizziness feeling caused when a user moves the head rapidly can be effectively alleviated, that is, a relatively good image display effect can be achieved, and user experience can be improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the flow chart of steps of the method for image rendering processing in an embodiment of the present disclosure.

FIG. 2 shows the flow chart of steps of the method for image rendering processing in an optimal embodiment of the present disclosure.

FIG. 3A shows the structure diagram of the device for image rendering processing in an embodiment of the present disclosure.

FIG. 3B shows the structure diagram of the device for image rendering processing in an optimal embodiment of the present disclosure.

FIG. 4 schematically shows the block diagram of an electronic device for executing the method of the present disclosure.

FIG. 5 schematically shows a storage unit for retaining or carrying program codes for realizing the method of the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, apparently, the described embodiments are not all but a part of the embodiments of the present disclosure. Based on the embodiments of the present disclosure, other embodiments obtained by a person skilled in the art under the condition that no creative work is made all belong to the protection scope of the present disclosure.

Aiming at the problems, an embodiment of the present disclosure has the key conception that a fitting curve is generated by detecting the state of the head of a user, a field angle of a target scene is confirmed according to the frame delay time and the fitting curve, that is, the moving state of a target head is predicted on the basis of the fitting curve, and estimated field angle deviation can be compensated, so that field angle deviation caused at the beginning and at the end of image frame rendering can be effectively reduced, the dizziness feeling caused when the user moves the head rapidly can be effectively alleviated, and a relatively good image display effect can be achieved.

FIG. 1 shows the flow chart of steps of the method for image rendering processing in an embodiment of the present disclosure, specifically including the following steps.

Step 101, detecting states of a target head to generate a target state sequence.

In a VR cinema system based on a mobile terminal, the view of an image can be changed through head tracking, so that the visual system and the motion perception system. of a user can be associated, and thus relatively real sensation can be achieved. Generally, the head of the user can be tracked by using a position tracker, and thus moving states of the head of the user can be confirmed, wherein the position tracker is also called as a position tracking device which refers to a device for space tracking and positioning, the position tracker is generally used together with other VR equipment such as a data hamlet, stereoscopic glasses and data gloves, and then a participant can freely move and turn around in a space without being restricted in a fixed spatial position. The VR system based on the mobile terminal can confirm the state of the head of the user by detecting the state of the head of the user, the field angle of an image can be confirmed on the basis of the state of the head of the user, and a relatively good image display effect can be achieved by rendering the image according to the confirmed field angle. What needs to be explained is that the mobile terminal refers to computer equipment which can be used in a moving state, such as a smart phone, a notebook computer and a tablet personal computer, which is not restricted in the embodiment of the present disclosure. In the embodiment of the present disclosure, a mobile phone is taken as an example to specifically describe the embodiment of the present disclosure but not being taken as restriction of the embodiment of the present disclosure.

As a specific example of an embodiment of the present disclosure, the VR system based on the mobile phone can be adopted to monitor the moving states of the head of the user by using auxiliary sensing equipment such as the hamlet, the sterioscopic glasses and the data gloves, that is, the head of the monitored user is taken as a target head of which the state is monitored to confirm state information of the target head relative to the display screen of the mobile phone. Based on corresponding state information of the target head, state data corresponding to a current state of the user can be acquired by calculation. For example, after the user wears a data hamlet, an angle of the target head relative to the display screen of the mobile phone can be calculated by monitoring turning states of the head (namely, the target head) of the user that is, state data can be generated. Specifically, the angle of the target head relative to the display screen of the mobile phone can be generated by calculation according to any one or more data such as a head direction, a moving direction and a moving speed corresponding to a current state of the user.

By adopting the VR system, the generated state data can be stored in a corresponding state sequence to generate a target state sequence corresponding to the target head, for example, angles of the target head A relative to the display screen of the mobile phone at different moments are sequentially stored in corresponding state sequences to form a target state sequence L_{A} corresponding to the target head A. Wherein n state data can be stored in the target state sequence L_{A}, and n is a positive integer such as 30, 10 or 50, which is not restricted in the embodiment of the present disclosure.

In an optimal embodiment of the present disclosure, the step 101 can also include the following sub-steps:
sub-step 1010, acquiring data acquired by a sensor to generate state data corresponding to the target head;
sub-step 1012, generating a target state sequence according to the generated, state data.

Step 103, when determining that the target head enters into a moving state, simulating the target state sequence to generate a fitting curve.

Actually, whether the target head enters into the moving state can be determined by monitoring the turning states of the target head in real time, that is, whether the target head moves relative to the display screen of the mobile phone is determined. Specifically, whether the target head enters into the moving state is determined according to the state data corresponding to the target head. For example, whether the angle of the target head relative to the display screen of the mobile phone is changed can be determined, and the situation that the target head enters into the moving state can be determined if the angle of the target head relative to the display screen of the mobile phone is changed; if the angle of the target head relative to the display screen of the mobile phone is not changed, the situation that the target head does not enter into the moving state can be determined, that is, the target head stills relative to the display screen of the immobile phone.

When the target head enters into the moving state, the VR system based on the mobile system can call a preset analog algorithm to simulate the target state sequence to generate a fitting curve N=S(t) corresponding to the target head, wherein N refers to the state data, and t refers to the time. On the basis of the fitting curve, the system can calculate corresponding state data N of the target head at each moment t, that is, on the basis of corresponding fitting curves of the target head, corresponding state data of the target head of the user at a next frame can be predicted through calculation. For example, assume that at a moment of the 50^{th} second, t is the value of S(t) at the 50^{th} second, and the result of calculation shows that S (the 50^{th} second) is 150 degrees, that is, the angle of the target head relative to the display screen of the mobile phone at the moment of the 50^{th} second is confirmed as 150 degrees.

Optionally, the step of simulating the target state sequence to generate the fitting curve can specifically include calling the preset analog algorithm to implement analog calculation on the state data of the target state sequence to generate the fitting curve.

Step 105, confirming a field angle of a target scene according to a pre-generated frame delay time and the fitting curve.

Specifically, the VR system can generate the frame delay time on the basis of historical data of image rendering. For example, time information t0 at the beginning of image frame rendering and time information t1 at the end of image frame rendering can be recorded, the time delay of an image flame from the beginning of rendering to display on the display screen can be obtained by calculating the difference between t0 and t1, and the time delay can be confirmed as frame delay time T. Of course, to improve the precision of the frame delay time T, the frame delay time T can be confirmed according to time delay of a plurality of image frames, for example, the frame delay time T can be confirmed according to the time delay of 60 image frames, that is, the time delay of the 60 image frames is counted, the average value of the time delay of the 60 image frames is calculated, the average value is taken as the frame delay time T, and a generation mode of the frame delay time is not restricted in the embodiment of the present disclosure.

When an image frame of a scene needs to be rendered, the scene is taken as a target scene, and a rendering moment of the target scene is confirmed on the basis of a frame delay time T which is generated in advance, for example, the sum of a current moment t3 and the frame delay time T is taken as the rendering moment of the target scene. On the basis of the fitting curve, the target state data corresponding to the rendering moment of the target scene can be calculated. By calculating on the basis of the target state data, the field angle corresponding to the target state data can be obtained, and the calculated field angle is taken as a field angle of the target scene, that is, estimated deviation is compensated at the beginning of rendering of the image frame of the target scene, so that field angle deviation caused at the beginning and at the end of image frame rendering can be effectively reduced, and thus a relatively good image display effect can be achieved.

Step 107, rendering the target scene on the basis of the field angle to generate a rendered image.

When the image is rendered, the field angle can be acquired by calculation of the VR system based on the mobile phone, the image frame of the target scene can be rendered, and thus the rendered image can be generated. Specifically, the VR system based on the mobile phone can adopt a rendering technology such as a Z buffer technology, a light tracking technology and a radiancy technology to calculate to obtain the field angle to render the image flame to generate the rendered image of the target scene, equivalently, a preset rendering realizing algorithm is called to calculate a data frame of the target scene for the field angle, to obtain rendered image data, that is, the rendered image is generated.

In the embodiment of the present disclosure, the VR system based on the mobile terminal can generate the target state sequence by detecting the states of the target head, and generate the fitting curve by simulating the target state sequence when determining that the target head enters into the moving state; on the basis of the frame delay time and the fitting curve, the field angle of the target scene can be confirmed, that is, the moving state of the target head can be predicted on the basis of the fitting curve, and the estimated field angle deviation can be compensated, so that field angle deviation caused at the beginning and at the end of rendering of the image frame can be effectively reduced, and the dizziness feeling caused when the user turns the head rapidly can be effectively alleviated, that is, a relatively good image display effect can be achieved, and the user experience can be improved.

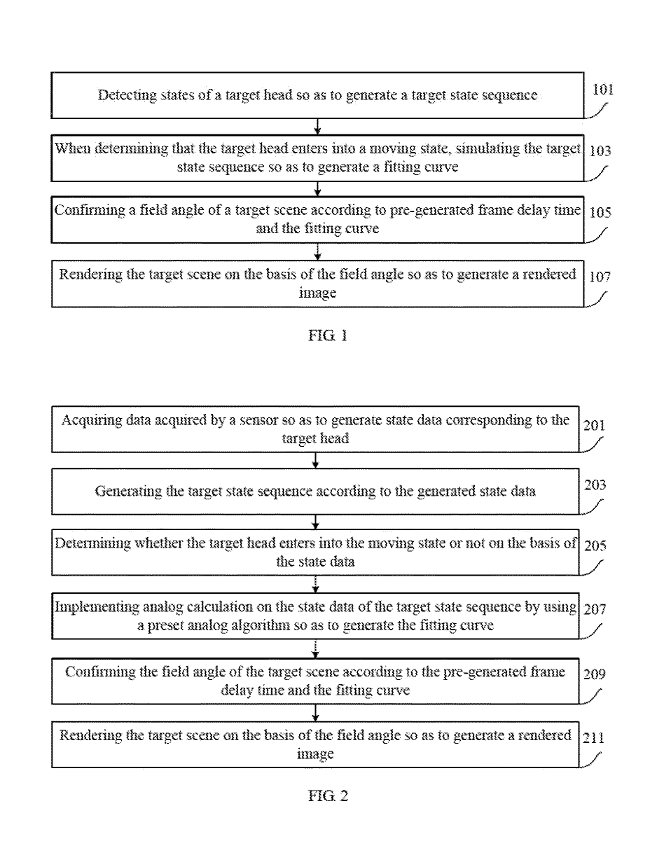

FIG. 2. shows the flow chart of steps of the method for image rendering processing in an embodiment of the present disclosure, specifically including the following steps.

Step 201, acquiring data acquired by a sensor to generate state data corresponding to the target head.

Actually, VR equipment such as the data hamlet, the sterioscopic glasses and the data gloves for monitoring the target head generally acquires data through the sensor. Specifically, a mobile phone posture (namely, a screen direction) can be detected by using a gyroscope and acceleration and a moving direction of the mobile can be detected by using an accelerometer, wherein the screen direction is equivalent to the head direction For example, after the head direction is confirmed, field angles of left and right eyes can be calculated by the VR system based on the mobile phone according to parameters such as upper, lower, left and right view ranges of the left and right eyes, and furthermore an angle of the target head relative to the display screen can be confirmed according to the field angles of the left and right eyes, that is, the state data are generated.

Step 203, generating the target state sequence according to the generated state data.

The VR system can sequentially store the generated state data into corresponding state sequences and generate the target state sequence corresponding to the target head, for example, angles N1, N2, N3 . . . Nn of the target head A relative to the display screen of the mobile phone at different moments can be sequentially stored in a corresponding state sequence LA, that is, the target state sequence LA corresponding to the target head A can be generated. To ensure the efficiency of image rendering and the precision of the calculated field angle of the target scene, preferably the target state sequence LA is set in a manner that sequences of 30 state data N can be stored, that is, 30 newly generated state data N can be stored in the target state sequence LA.

Specifically, within 1 second, a plurality of data can be acquired by the sensor, a plurality of state data can be generated by the VR system based on the mobile phone, the plurality of state data generated within every 1 second are counted to generate the average value of all state data generated within every 1 second, and the average value is taken as corresponding state data within the 1 second, and is stored in the target state sequence LA.

The VR system based on the mobile phone can form the target state sequence LA according to historically generated state data and generate the fitting curve corresponding to the target head. When the latest state data are generated, deviation of the latest state data relative to the fitting curve can be confirmed by calculation, for example, the time of the latest generation is calculated on the basis of the fitting curve to acquire virtual state data corresponding to the time that the latest state data are generated, furthermore the difference between the virtual state data and the latest state data can be calculated, and the difference is taken as the deviation of the latest state data and the fitting curve to determine whether the deviation of the latest state data and the fitting curve is greater than the preset deviation threshold. When the deviation of the latest state data and the fitting curve is not greater than the preset deviation threshold, the target state sequence LA is updated on the basis of the latest state data; when the deviation of the latest state data and the fitting curve is greater than the preset deviation threshold, the latest state data are determined as abnormal data, and the latest state data are abandoned.

Step 205, determining whether the target head enters into the moving state according to the state data.

Specifically, whether the state data corresponding to the target head are changed can be determined on the basis of all state data stored in the target state sequence LA, and the situation that the user enters into the moving state can be confirmed if the state data corresponding to the target head are changed.

In one optimal embodiment of the present disclosure, the step 205 can include the following sub-steps.

Sub-step 2050, counting the state data of the target state sequence to confirm a state difference.

Actually, all state data in the target state sequence LA can be compared to confirm a smallest value S and a biggest value B of all state data in the target state sequence LA, and a mean corresponding to all state data in the target state sequence LA can be obtained through calculation. The difference between the biggest value B and the mean M can be taken as the state difference corresponding to the target head in the VR system based on the mobile phone, the difference between the smallest value S and the mean M can be taken as the state difference corresponding to the target head, or even the smallest value S and the biggest value B can be taken as the state difference corresponding to the target head, which is not restricted in the embodiment of the present disclosure, and preferably the difference between the smallest value S and the mean M or the difference between the biggest value B and the mean M is taken as the state difference corresponding to the target head.

Sub-step 2052, determining whether the state difference is greater than a preset moving threshold.

The VR system based on the mobile phone can preset the moving threshold for determining whether the target head enters into the moving state. Specifically, by determining whether the state difference corresponding to the target head is greater than the preset moving threshold, whether the target head enters into the moving state can be confirmed. Like the examples above, the state data are the angles of the target head relative to the display screen of the mobile phone, the VR system based on the mobile phone can preset the moving threshold as 10 degrees, and whether the target head enters into a rapid turning state can be confirmed by detecting whether the state difference corresponding to the target head is greater than 10 degrees.

Sub-step 2054, determining that the target head enters into the moving state when the state difference is greater than the moving threshold.

When the state different corresponding to the target head is greater than the moving threshold, the situation that the target head enters into the rapid turning state can be confirmed, that is, entering into the moving state. For example, the situation that the target head enters into the rapid turning state can be determined if the difference between the smallest value S and the mean M is greater than 10 degrees, that is, entering into the moving state; or the situation that the target head enters into the moving state can be determined when the difference between the biggest value B and the mean M is greater than 10 degrees.

Of course, the situation that the target head does not enter into the moving state can be determined if the state different corresponding to the target head is not greater than the moving threshold, equivalently, the target head stills relative to the display screen.

Step 207, implementing analog calculation on the state data of the target state sequence by using a preset analog algorithm to generate the fitting curve.

Specifically, the VR system based on the mobile phone can set the analog algorithm on the basis of a least square method. When the target head enters into the moving state, the preset analog algorithm can be called to implement analog calculation on the state data of the target state sequence by using the least square method to generate the fitting curve N=S(t) corresponding to the target head.

Step 209, confirming the field angle of the target scene according to the pre-generated frame delay time and the fitting curve.

In one optimal embodiment of the present disclosure, the step 209 can include the following sub-steps:

Sub-step 2090, confirming a rendering moment of the target scene on the basis of the frame delay time.

When the target scene needs to be rendered, the VR system based on the mobile phone acquires current time t3, and the sum of the current time t3 and the frame delay time T is taken as the rendering moment of the target scene.

Sub-step 2092, calculating target state data corresponding to the rendering moment on the basis of the fitting curve.

In the embodiment of the present disclosure, the VR system based on the mobile phone can calculate the target state data corresponding to the rendering moment of the target scene on the basis of the fitting curve. For example, the rendering moment (t3+T) of the target scene is taken as t which is substituted into the fitting curve N=S(t) to obtain corresponding state data N3 of the target head at the moment (t3+T) through calculation, wherein N3=S(t3+T), that is, the corresponding state data N3 at the rendering moment (t3+T) are taken as the target state data.

Sub-step 2094, calculating on the basis of the target state data to generate the field angle.

The VR system based on the mobile phone calculates on the basis of the target state data N3 to obtain the field angle of the target scene. When the image frame of the target scene is rendered, the target state data N3 are adopted for rendering, so that the field angle deviation caused at the beginning and at the end of the rendering of the image frame can be effectively reduced.

Step 211, rendering the target scene on the basis of the field angle to generate the rendered image.

In the embodiment of the present disclosure, the VR system based on the mobile terminal predicates the moving, states of the target head on the basis of the fitting curve to compensate estimated field angle deviation, so that the field angle deviation caused at the beginning and at the end of rendering of the image frame can be effectively reduced, a scene image which is actually watched by eyes of the user has relatively small deviation from a current position, the dizziness feeling caused when the user turns the head rapidly can be effectively alleviated, a relatively good image display effect can be achieved, and the user experience can be improved.

What needs to be explained is that to be described concisely, the method in the embodiments is expressed as a combination of a series of action, however a person skilled in the art shall understand that the embodiment of the present disclosure is not restricted by the sequence of the described action as some steps can be implemented in other sequences or simultaneously in the embodiments of the present disclosure. Secondly, the person skilled in the art shall also understand that the embodiments in the present disclosure are all optimal embodiments, and action involved in the embodiments is not definitely essential in the embodiments of the present disclosure.

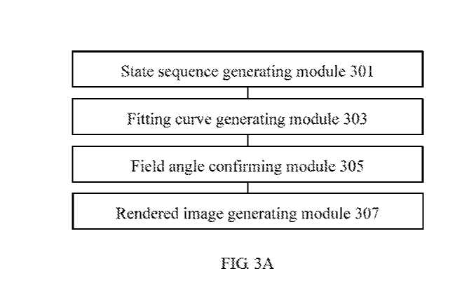

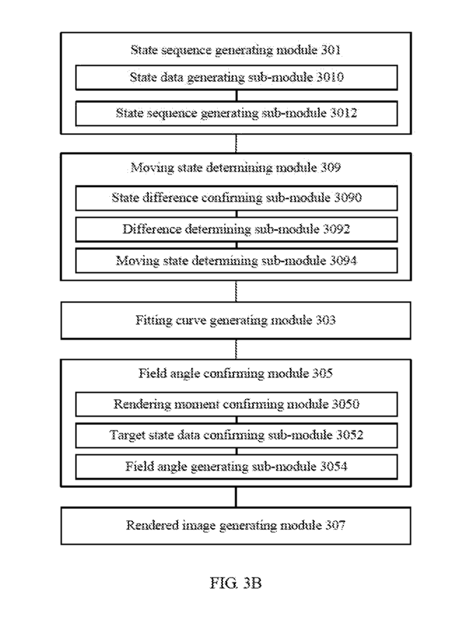

FIG. 3A shows the structure diagram of the device for image rendering processing in an embodiment of the present disclosure, specifically including:
a state sequence generating module 301 for detecting states of a target head to generate a target state sequence;
a fitting curve generating module 303 for simulating the target state sequence to generate a fitting curve when determining that the target head enters into a moving state;
a field angle confirming module 305 for confirming a field angle of a target scene according to a pre-generated frame delay time and the fitting curve;
a rendered image generating module 307 for rendering the target scene on the basis of the field angle to generate a rendered image.

On the basis of FIG. 3A. optionally, the device for image rendering processing can further include a moving state determining module 309, see FIG. 3B.

Wherein the moving state determining module 309 is used for determining whether the target head enters into the moving state according to the state data.

In one optimal embodiment of the present disclosure, the moving state determining, module 309 can further include the following sub-modules:
a state difference confirming sub-module 3090 for counting the state data of the target state sequence to confirm a state difference;
a difference determining sub-module 3092 for determine whether the state difference is greater than a preset moving threshold;
a moving state determining sub-module 3094 for determining whether the target head enters into the moving state when the state difference is greater than the moving threshold.

Optionally, the state sequence generating module 301 can include a state data generating sub-module 3010 and a state sequence generating sub-module 3012, wherein the state data generating sub-module 3010 is used for acquiring data acquired by a sensor to generate state data corresponding to the target head; the state sequence generating sub-module 3012 is used for generating the target state sequence on the basis of the generated state data.

The fitting curve generating module 303 can be specifically used for implementing analog calculation on the state data of the target state sequence by using a preset analog algorithm to generate the fitting curve.

In an optimal embodiment of the present disclosure, the field angle confirming module 305 can include the following sub-modules:
a rendering moment confirming module 3050 for confirming a rendering moment of the target scene on the basis of the frame delay time;
a target state data confirming sub-module 3052 for calculating target state data corresponding to the rendering moment on the basis of the fitting curve;
a field angle generating sub-module 3054 for calculating by using the target state data to generate the field angle.

As the device of the embodiments is generally similar to the method of the embodiments, the device is relatively concisely described see related parts in description of the method of the embodiments.

The embodiments of the present disclosure are all described in a progressive mode, differences of the embodiments from those of others are particularly described, and refer to one another about similar parts of the embodiments.

A person skilled in the art shall understand that the embodiments of the present disclosure can be provided in manners of methods, devices or computer program products. Therefore, the embodiments of the present disclosure can be complete hardware embodiments, complete software embodiments or embodiments with the combination of software and hardware. Moreover the embodiments of the present disclosure can be computer program products which are implemented in one or more computer available storage mediums (including but not limited to a disk storage, a CD-ROM, an optimal memory and the like) with computer available program codes.

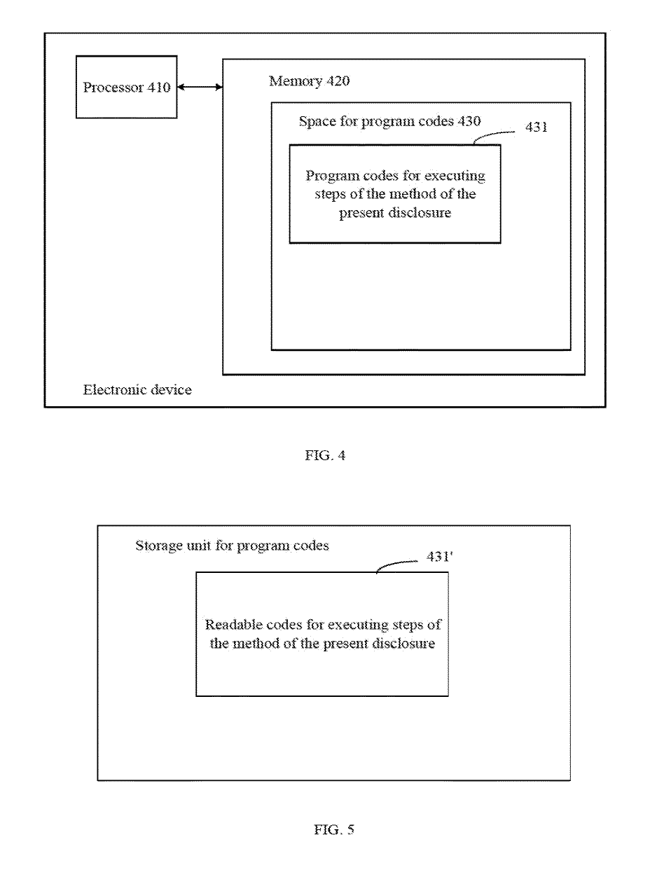

For example, FIG. 4 illustrates a block diagram of an electronic device for executing the method according the disclosure. The electronic device may be the mobile terminal above. Traditionally, the electronic device includes a processor 410 and a computer program product or a computer readable medium in form of a memory 420. The memory 420 could be electronic memories such as flash memory, EEPROM (Electrically Erasable Programmable Read—Only Memory), EPROM, hard disk or ROM. The memory 420 has a memory space 430 for executing program codes 431 of any steps, in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the electronic device as shown in FIG. 4. The program codes may be compressed for example in an appropriate form. Usually, the memory cell includes computer readable codes 431′ which can be read for example by processors 410. When these codes are operated on the electronic device, the electronic device may execute respective steps in the method as described above.

The embodiments of the present disclosure are described referring to the flow charts and/or block diagrams of the methods, terminal equipment (system) and computer program products of the embodiments of the present disclosure. Do understand that each procedure and/or block in the flow charts and/or block diagrams and combinations of procedures and/or blocks in the flow charts and/or the block diagrams can be realized by using computer program instructions. The computer program instructions can be provided into a processor of a general-propose computer, a special computer, a built-in processor or other programmable data processing terminal equipment to generate a machine which enables instructions executed by the processor of the computer or other programmable data processing terminal equipment to generate a device for realizing functions appointed in one procedure or multiple procedures in the flow charts and/or one block or multiple blocks in the block diagrams.

The computer program instructions can be also stored in a computer readable memory capable of instructing the computer or other programmable data processing terminal equipment to work in a specific mode, to enable instructions stored in the computer readable memory to generate a product including an instruction device for realizing appointed functions in one procedure or multiple procedures of the flow charts and/or one block or multiple blocks of the block diagrams.

The computer program instructions can be also loaded to the computer or other programmable data processing terminal equipment, so that a series of operation steps can be executed in the computer or other programmable data processing terminal equipment to generate processing realized by the computer, then the instructions executed in the computer or other programmable data processing terminal equipment are used for providing steps for realizing appointed functions in one procedure or multiple procedures of the flow charts and/or one block or multiple blocks of the block diagrams.

Although optimal ones of the embodiments of the present disclosure are described, a person skilled in the art can make additional change and modification to the embodiments once learning basic creative concepts, therefore, the claims as follows intend to be interpreted as including the optimal embodiments and all changes and modifications within the scope of the embodiments of the present disclosure.

The final description is that in the text, the relationship terms such as the first and the second are only used for distinguishing one entity or operation from another entity or operation but not requiring or hinting that the entity or operation has the actual relationship or sequence. In addition, the terms “comprise”, “include” or any other variant intend to cover nonexclusive inclusion, so that procedures, methods, products or devices including a series of elements not only include the elements, but also other elements which are not specifically listed, or include inherent elements of the procedures, the methods, the products or the devices. Under the condition of no more limit, elements defined in the sentence “include one . . . ” do not exclude that the procedures, the methods, the products or the devices including the elements also have other identical elements.

The method for image rendering processing and the device for image rendering processing, which are provided by the present disclosure, are specifically described, specific examples are taken to explain principles and modes of execution of the present disclosure in the text, and the description about the embodiments is only to promote understanding about the methods and the key concepts of the present disclosure; meanwhile a person skilled in the art can make change on specific modes of execution and application ranges on the basis of the concepts of the present disclosure, and to sum up, the content of the specification shall not be interpreted as restriction on the present disclosure.

What is claimed is:

1. A method for image rendering processing, at an electronic device, comprising:
detecting states of a target head to generate a target state sequence;
when determining that the target head enters into a moving state, simulating the target state sequence to generate a fitting curve;
confirming a field angle of a target scene according to pre-generated frame delay time and the fitting curve;
rendering the target scene on the basis of the field angle to generate a rendered image.

2. The method according to claim 1, wherein detecting the states of the target head to generate the target state sequence comprises:
acquiring data acquired by a sensor to generate state data corresponding to the target head;
generating the target state sequence according to the generated state data.

3. The method according to claim 2, wherein after the target state sequence is generated, the method further comprising:
determining whether the target head enters into the moving state.

4. The method according to claim 3, wherein determining whether the target head enters into the moving state according to the state data comprises:
counting the state data of the target state sequence to confirm a state difference;
determining whether the state difference is greater than a preset moving threshold;
when the state difference is greater than the moving threshold, determining that the target head enters into the moving state.

5. The method according to claim 2, wherein simulating the target state sequence to generate the fitting curve comprises:
implementing analog calculation on the state data of the target state sequence by using a preset analog algorithm to generate the fitting curve.

6. The method according to claim 1, wherein confirming the field angle of the target scene according to the pre-generated frame delay time and the fitting curve comprises:
confirming a rendering moment of the target scene on the basis of the frame delay time;
calculating target state data corresponding to the rendering moment on the basis of the fitting curve;
calculating on the basis of the target state data to generate the field angle.

7. An electronic device for image rendering processing, comprising:
at least one processor; and
a memory communicably connected with the at least one processor for storing instructions executable by the at least one processor, wherein execution of the instructions the at least one processor causes the at least one processor to:
detect states of a target head to generate a target state sequence;
simulate the target state sequence to generate a fitting curve when determining that the target head enters into a moving state;
confirm a field angle of a target scene according to pre-generated frame delay time and the fitting curve;
render the target scene on the basis of the field angle to generate a rendered image.

8. The electronic device according to claim 7, wherein the step to detect states of a target head to generate a target state sequence comprises:
acquire data acquired by a sensor to generate state data corresponding to the target head;
generate the target state sequence on the basis of the generated state data.

9. The electronic device according to claim 8, wherein execution of the instructions by the at least one processor causes the at least one processor to further: determine whether the target head enters into the moving state according to the state data.

10. The electronic device according to claim 9, wherein the step to determine whether the target head enters into the moving state according to the state data comprises:
count the state data of the target state sequence to confirm a state difference;
determine whether the state difference is greater than a preset moving threshold;
determine whether the target head enters into the moving state when the state difference is greater than the moving threshold.

11. The electronic device according to claim 8, wherein the step to simulate the target state sequence to generate a fitting curve when determining that the target head enters into a moving state comprises:
implement analog calculation on the state data of the target state sequence by using a preset analog algorithm to generate the fitting curve.

12. The electronic device according to claim 7, wherein the step to confirm a field angle of a target scene according to pre-generated frame delay time and the fitting curve comprises:
confirm a rendering moment of the target scene on the basis of the frame delay time;
calculate target state data corresponding to the rendering moment on the basis of the fitting curve;
calculate on the basis of the target state data to generate the field angle.

13. A non-transitory computer readable medium storing executable instructions that, when executed by an electronic device, cause the electronic device to:
detect states of a target head to generate a target state sequence;
simulate the target state sequence to generate a fitting curve when determining that the target head enters into a moving state;
confirm a field angle of a target scene according to pre-generated frame delay time and the fitting curve;
render the target scene on the basis of the field angle to generate rendered image.

14. The non-transitory computer readable medium according to claim 13, wherein the step to detect states of a target head to generate a target state sequence comprises:
acquire data acquired by a sensor to generate state data corresponding to the target head;
generate the target state sequence on the basis of the generated state data.

15. The non-transitory computer readable medium according to claim 14, wherein the electronic device is further caused to:
determine whether the target head enters into the moving state according to the state data.

16. The non-transitory computer readable medium according to claim 15, wherein the step to determine whether the target head enters into the moving state according to the state data comprises:
count the state data of the target state sequence to confirm a state difference;
determine whether the state difference is greater than a preset moving threshold;
determine whether the target head enters into the moving state when the state difference is greater than the moving threshold.

17. The non-transitory computer readable medium according to claim 14, wherein the step to simulate the target state sequence to generate a fitting curve when determining that the target head enters into a moving state comprises:
implement analog calculation on the state data of the target state sequence by using a preset analog algorithm to generate the fitting curve.

18. The non-transitory computer readable medium according to claim 13, wherein the step to confirm a field angle of a target scene according to pre-generated frame delay time and the fitting curve comprises:
confirm a rendering moment of the target scene on the basis of the frame delay time;
calculate target state data corresponding to the rendering moment on the basis of the fitting curve;
calculate on the basis of the target state data to generate the field angle.
